(19) United States
(12) Patent Application Publication
(10) Pub. No.: US 2025/0354701 A1
(43) Pub. Date: Nov. 20, 2025

(54) FILTER APPARATUS

(71) Applicant: SEIKO EPSON CORPORATION, Tokyo (JP)

(72) Inventors: Tomoaki YAMAZAKI, Matsumoto (JP); Manabu WATABE, Shiojiri (JP); Hiroshi TANAKA, Matsumoto (JP); Akira ANAMI, Kitakyushu (JP)

(21) Appl. No.: 19/208,669

(22) Filed: May 15, 2025

(30) Foreign Application Priority Data
May 17, 2024 (JP) 2024-080762
Jan. 29, 2025 (JP) 2025-012816

(51) Int. Cl. F24F 8/108; F24F 11/74; F24F 110/10; F24F 110/30; F24F 110/40

(52) U.S. Cl. CPC F24F 8/108; F24F 11/74; F24F 2110/10; F24F 2110/30; F24F 2110/40

(57) ABSTRACT

A filter apparatus includes a filter, a pipe, a blower that sucks, through the pipe, air filtered by the filter, a wind speed sensor that measures a mass flow rate of gas flowing through the pipe, a temperature sensor that measures a temperature, a pressure sensor that measures an air pressure, and a processor that controls suction of the blower, based on the measured air pressure, the measured temperature, and the measured mass flow rate.

The present application is based on, and claims priority from JP Application Serial Number 2024-080762, filed May 17, 2024, and JP Application Serial Number 2025-012816, filed Jan. 29, 2025, the disclosures of which are hereby incorporated by reference herein in their entirety.

### BACKGROUND

### 1. Technical Field

The present disclosure relates to a filter apparatus.

### 2. Related Art

A sheet manufacturing apparatus for manufacturing sheets from pieces of paper such as waste paper through a dry process collects, using a waste powder collecting unit, waste powder such as short fibers unsuitable for manufacturing the sheets and colorants contained in the pieces of paper, and discards the waste powder. In this case, a wind speed sensor attached to a flow straightener controls the rotational speed of a waste powder blower so that the volume flow rate of the waste powder flowing through the waste powder collecting unit is constant. However, there is a problem in that the wind speed detected by the wind speed sensor is a mass flow rate and thus differs from the volume flow rate. In addition, an airflow meter capable of measuring the volume flow rate is also known, but the cost thereof is higher than that of the mass flow rate type wind speed sensor.

For example, JP-A-2010-38714 discloses a volume flow rate meter for a cooling fan, including a wind receiving plate that is provided in a duct and receives a flow of wind generated by the cooling fan and a converter that converts an inclination angle of the wind receiving plate into a volume flow rate. According to JP-A-2010-38714, it is possible to measure a very small volume flow rate of the cooling fan.

However, in the airflow meter of JP-A-2010-38714, the wind receiving plate is provided in the duct, which results in a significant pressure loss.

### SUMMARY

A filter apparatus according to an aspect of the present disclosure includes a filter, a pipe, a blower that sucks, through the pipe, air filtered by the filter, a wind speed sensor that measures a mass flow rate of gas flowing through the pipe, a temperature sensor that measures a temperature, a pressure sensor that measures an air pressure, and a processor that controls suction of the blower, based on the air pressure measured by the pressure sensor, the temperature measured by the temperature sensor, and the mass flow rate measured by the wind speed sensor.

### BRIEF DESCRIPTION OF THE DRAWINGS

FIG. 1 is a perspective view illustrating a schematic configuration of a waste powder collecting apparatus according to a first embodiment.

FIG. 2 is a perspective view of the waste powder collecting apparatus as viewed from the opposite side of FIG. 1.

FIG. 3 is a perspective view illustrating a schematic configuration of an air volume adjusting device.

FIG. 4 is a side cross-sectional view of a flow straightener along line IV-IV of FIG. 3.

FIG. 5 is a flowchart illustrating the flow of an air volume adjusting method.

FIG. 6 is a schematic configuration diagram of a sheet manufacturing apparatus according to a second embodiment.

### DESCRIPTION OF EMBODIMENTS

### First Embodiment

### Overview of Waste Powder Collecting Apparatus

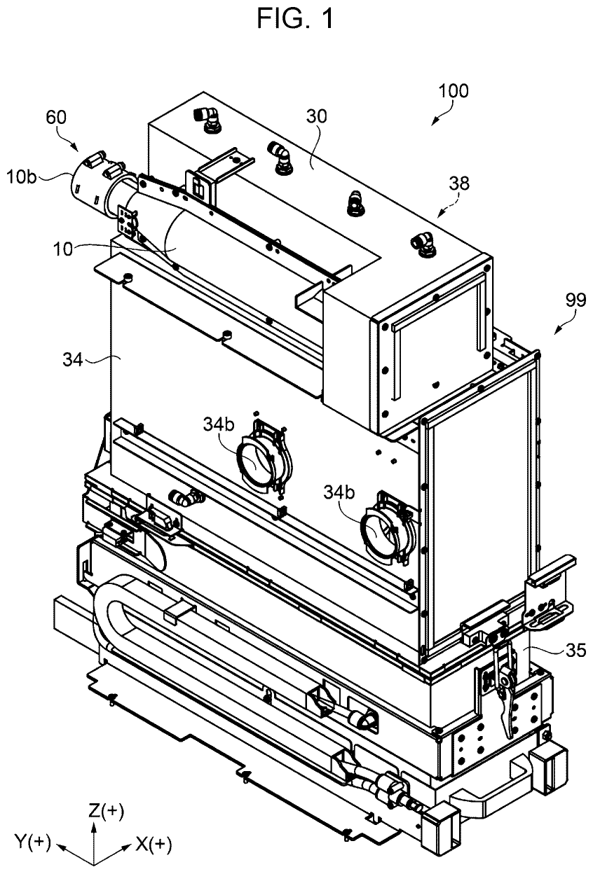

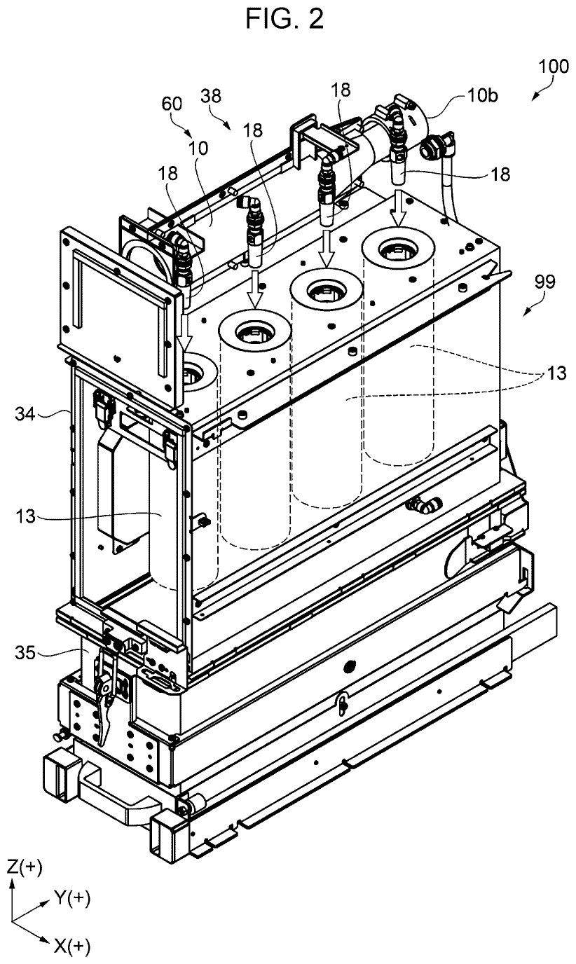

FIG. 1 is a perspective view illustrating a schematic configuration of a waste powder collecting apparatus as a filter apparatus according to a first embodiment. FIG. 2 is a perspective view of the waste powder collecting apparatus as viewed from the opposite side of FIG. 1. In FIG. 2, illustration of a part of the configuration is omitted in order to facilitate understanding of the internal configuration.

The schematic configuration of a waste powder collecting apparatus 100 according to the present embodiment will be described with reference to FIGS. 1 and 2. Each of these drawings illustrates three axes orthogonal to each other: an X-axis, a Y-axis, and a Z-axis. In the present embodiment, the Z-axis direction is the vertical direction, but the present disclosure is not limited thereto. A direction along the X-axis is referred to as an “X direction”, a direction along the Y-axis is referred to as a “Y direction”, and a direction along the Z-axis is referred to as a “Z direction”. Further, the tip side of the arrow in each axial direction is also referred to as a “plus side”, and the base side of the arrow is also referred to as a “minus side”. For example, the Y direction refers to both the plus side of the Y direction and the minus side of the Y direction. In addition, the plus side of the Z direction is referred to as an “upper side”, and the minus side of the Z direction is referred to as a “lower side”. In addition, in each of the following drawings, description may be given with dimensions and scales different from actual dimensions and scales to facilitate understanding of the description.

The waste powder collecting apparatus 100 of the present embodiment is a filtration type dust collecting apparatus that collects dust in exhaust gas of an industrial facility, a so-called bag filter apparatus, and can be used for collection of powder in the exhaust gas, recovery of crushed products, local dust collection, and the like.

The waste powder collecting apparatus 100 includes a filter section 34, a waste powder box 35, an air volume adjusting device 60 including a flow straightener 10, a cover member 30, a reverse airflow generator 38, and the like.

As illustrated in FIG. 1, the waste powder collecting apparatus 100 has a vertically long rectangular parallelepiped shape, and has a structure in which the waste powder box 35, the filter section 34, the air volume adjusting device 60, and the cover member 30 are stacked in this order from the bottom. These components are assembled into a housing 99 mainly including the filter section 34, and form an integrated apparatus.

As illustrated in FIG. 2, the filter section 34 includes four cylindrical filters 13. The number of the filters 13 is not limited to four, and may be any number greater than one. The filters 13 are cylindrical filter bags (filter cloths) and extend in the vertical direction. As illustrated in FIG. 1, two intake ports 34b are provided on one side surface of the filter section 34. A pipe (not illustrated) from an upstream apparatus is connected to the intake ports 34b, and gas containing dust flows into the filter section 34 from the pipe.

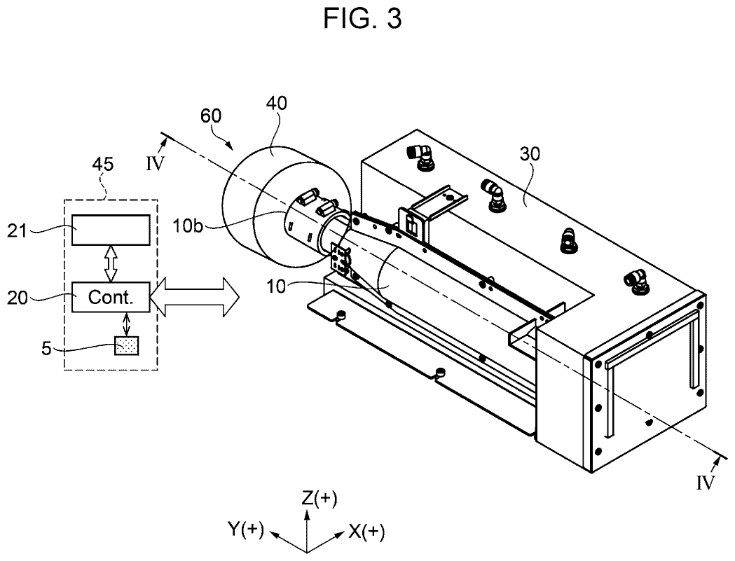

The gas filtered by the four filters 13 is sucked into the inside of the cover member 30 (FIG. 1), then passes through the flow straightener 10 of the air volume adjusting device 60, and is discharged from an exhaust port 10b. The cover member 30 functions as an exhaust flow path that guides the exhaust gas filtered by the filter section 34 to the flow straightener 10. The flow straightener 10 is an exhaust gas guiding pipe, and a blower 40 (FIG. 3) is provided on the downstream side of the exhaust port 10b to suck the gas in the filter section 34.

In other words, the waste powder collecting apparatus 100 includes the filter section 34, the flow straightener 10 that discharges the exhaust gas filtered by the filter section 34 from the exhaust port 10b, and the blower 40 as a blower section that sucks the exhaust gas.

As illustrated in FIG. 2, the reverse airflow generator 38 is provided next to the flow straightener 10. FIG. 2 illustrates a state in which the cover member 30 is removed, and the reverse airflow generator 38 includes four ejecting heads 18. The ejecting heads 18 are disposed at corresponding positions above the filters 13. A pipe is connected to the ejecting heads 18 from a compressor (not illustrated), and compressed air is supplied to the ejecting heads 18. During the operation of the waste powder collecting apparatus 100, dust such as powder adheres to the outer surfaces of the filters 13.

The ejecting heads 18 blow off the dust on the outer surfaces of the filters 13 by ejecting air into the filter bags in pulses at regular intervals. In a preferred example, the ejecting heads 18 eject air to the four filters 13 in order. The dust that has been blown off falls into the waste powder box 35 by gravity.

### Configurations of Air Volume Adjusting Device And Flow Straightener

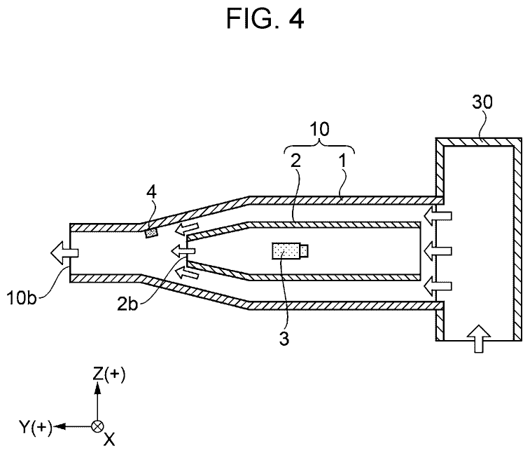

FIG. 3 is a perspective view illustrating a schematic configuration of the air volume adjusting device 60, and corresponds to FIG. 1. FIG. 4 is a side cross-sectional view of the flow straightener 10 along line IV-IV of FIG. 3.

The air volume adjusting device 60 includes the flow straightener 10, the blower 40, a controller 20, a storage unit 21, and the like.

As illustrated in FIG. 4, the flow straightener 10 includes a first pipe 1, a second pipe 2, a wind speed sensor 3, a temperature sensor 4, and the like.

The first pipe 1 is a cylindrical exhaust pipe whose base end on the upstream side is connected to the cover member 30. The first pipe 1 has a tapered shape that extends toward the plus side of the Y direction and then gradually decreases in diameter toward the downstream side. The tapered shape is also referred to as a narrowed portion. The second pipe 2 has a shape that is one size smaller than that of the first pipe 1, and is concentrically provided in the first pipe 1. The gas in the cover member 30 is sucked from the two base end sides of the first pipe 1 and the second pipe 2 as indicated by arrows in FIG. 4. The gas sucked into the second pipe 2 passes through the second pipe 2 to exit from an exhaust port 2b, then merges with the gas flowing through the first pipe 1 at the tapered portion of the first pipe 1 to advance to the downstream side, and is discharged from the exhaust port 10b of the first pipe 1. The portion where the two airflows merge is also referred to as a merging portion.

As described above, the flow straightener 10 adopts the double annular structure in which the second pipe 2 is concentrically disposed in the first pipe 1, and both the first pipe 1 and the second pipe 2 have the narrowed portions on the downstream side. The flow straightener 10 thereby can suppress the generation of a turbulent flow and make the gas flow to the downstream side in a stable state without significantly disturbing the airflow. The wind speed sensor 3 as a mass flow rate detector is attached to the downstream side of the middle inside the second pipe 2. In a preferred example, the wind speed sensor 3 is a thermal flow sensor. The thermal flow sensor, for example, includes a heater constituted of micro-electromechanical systems (MEMS), a thermopile on the upstream side of the heater, and a thermopile on the downstream side of the heater, and detects a temperature difference associated with the flow of gas as an electromotive force difference, thereby detecting the wind speed as a mass flow rate. This principle can make the pressure loss by the thermal flow sensor extremely small. The wind speed sensor 3 is electrically connected to the controller 20 via an interface circuit (not illustrated). Note that the wind speed sensor 3 is not limited to the thermal flow sensor.

The temperature sensor 4 as a temperature detector is attached to the downstream side of the merging portion inside the first pipe 1. In a preferred example, the temperature sensor 4 is a thermistor. The temperature sensor 4 is electrically connected to the controller 20 via an interface circuit (not illustrated). The temperature sensor 4 measures the temperature of the exhaust gas of the flow straightener 10. Note that the temperature sensor 4 is not limited to the thermistor, and may be a contact temperature sensor or a non-contact temperature sensor.

The blower 40 is an exhauster, and in a preferred example, is a centrifugal blower. Note that the blower 40 is not limited to the centrifugal blower, and may be any blower having a sufficient exhaust capability. The blower 40 is connected to an internal space of the air volume adjusting device 60 and is also connected to the outside of the device.

The controller 20 and the storage unit 21 are constituted of a plurality of integrated circuits and electronic components mounted on a control substrate 45. The control substrate 45 is a control substrate incorporated in a control device of the waste powder collecting apparatus 100 or a controller of a host device, and is disposed in an environment outside the waste powder collecting apparatus 100. The controller 20 includes one or a plurality of processors, and integrally controls each section of the air volume adjusting device 60 according to a control program stored in the storage unit 21.

The storage unit 21 includes a random-access memory (RAM) and a read-only memory (ROM). The RAM is used for temporary storage of various types of data and the like, and the ROM stores a control program for controlling the operation of the air volume adjusting device 60, accompanying data, and the like. As the control program, a start-up program for instructing the order and contents of processing for starting up the air volume adjusting device 60, an air volume adjusting program for controlling the rotational speed of the blower 40 so that the volume flow rate of gas flowing into the filter section 34 is constant, and the like are stored.

A pressure sensor 5 as a pressure detector is electrically connected to the controller 20 via an interface circuit (not illustrated). The pressure sensor 5 is a piezoresistive air pressure sensor in a preferred example, and is mounted on the control substrate 45. The pressure sensor 5 measures the air pressure of a space in which the control substrate 45 is disposed. This space is a space to which the gas is discharged by the blower 40, and is also a source from which the air flowing into the filter section 34 is sucked. Therefore, the pressure detected by the pressure sensor 5 is related to the pressure at the position of the wind speed sensor 3, and the pressure at the position of the wind speed sensor 3 can be estimated by correcting the pressure detected by the pressure sensor 5 by calculation. Note that the pressure sensor 5 is not limited to a piezoresistive type, and may be any sensor that can detect air pressure.

In the present embodiment, the flow straightener 10 includes the first pipe 1, the second pipe 2 disposed inside the first pipe 1, the wind speed sensor 3 disposed in the second pipe 2 as a wind speed detector for measuring the mass flow rate of gas flowing through the second pipe 2, the temperature sensor 4 disposed in the first pipe 1 as a temperature detector for measuring the temperature of exhaust gas, and the pressure sensor 5 disposed outside the flow straightener 10 as a pressure detector for measuring the pressure of outside air.

### Air Volume Adjusting Method

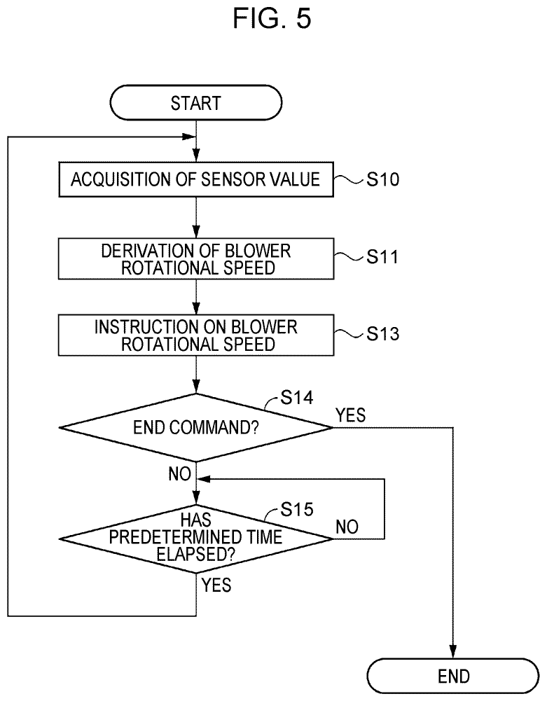

FIG. 5 is a flowchart illustrating the flow of an air volume adjusting method.

Here, a method of adjusting the volume flow rate will be described mainly with reference to FIG. 5 and other drawings as appropriate. Each of the following steps is executed by the controller 20 executing the air volume adjusting program of the storage unit 21 to control each section including the blower 40.

In step S10, the wind speed sensor 3 acquires a mass flow rate value M, the temperature sensor 4 acquires a temperature value T (K), and the pressure sensor 5 acquires an air pressure value P. The detected data is transmitted to the controller 20. The current rotational speed of the blower 40 is denoted as I. The target volume flow rate value is denoted as q. It is desirable that the air pressure value P be acquired by measuring the air pressure at the position where the wind speed sensor 3 is provided. However, in the present embodiment, the atmospheric pressure in the environment where the waste powder collecting apparatus 100 is installed, which is detected by the pressure sensor 5, is used instead of the air pressure at the position where the wind speed sensor 3 is provided.

In step S11, a corrected rotational speed i of the blower 40 is derived. The corrected rotational speed i is calculated by substituting the value acquired in step S10 into Equation (1) below, where x is a predetermined constant.

$$i = I α qP / TM \qquad Equation ( 1 )$$

Equation (1) above has been derived as follows. According to the ideal gas law, Equation (2) below holds.

$$P / RT = n / V \qquad Equation ( 2 )$$

For the relationship between the mass flow rate value M acquired by the wind speed sensor 3 and the volume flow rate value Q, Equation (3) below holds, where ρ is the density of fluid.

$$ρ = M / Q \qquad Equation ( 3 )$$

Since the amount of substance and the mass of gas are proportional to each other, Equation (4) below holds, where B is a proportional constant.

$$ρ = n β / V \qquad Equation ( 4 )$$

From Equations (2), (3), and (4), P/RT can be expressed as Equation (5) below.

$$P / RT = M / β Q \qquad Equation ( 5 )$$

Replacing β/R with constant ∝ and rewriting Equation (5) into an equation for Q yields Equation (6) below.

$$Q = TM / α P \qquad Equation ( 6 )$$

Since the rotational speed of the blower 40 and the volume flow rate are substantially proportional to each other, the target value/current value can be expressed as Equation (7) below.

$$i / I = α qP / TM \qquad Equation ( 7 )$$

Equation (7) is rewritten as Equation (1).

It is desirable that T, P, and M be values at the same place in the pipes. However, in the present embodiment, T, P, and M are measured at different places and, moreover, contain measurement errors depending on the performance of the sensors. Since a also depends on the components in the air, it is not strictly a numerical value that can be predetermined as a constant and contains an error relative to a predetermined constant value. Therefore, i calculated by Equation (1) also contains an error. However, when the error of i calculated by Equation (1) is smaller than that of the volume flow rate required for the blower 40, the calculation in step S11 is sufficient.

In practice, the inventors used the wind speed sensor 3 with an error of ±2% and the temperature sensor 4 and the pressure sensor 5 with an error of ±0.5% in trial manufacturing. Furthermore, the deviation due to the difference between the position of the wind speed sensor 3 and the positions of the temperature sensor 4 and the pressure sensor 5 could be suppressed to an error of approximately ±0.5% by correction using a correction value measured in advance. Moreover, a contains a deviation of approximately ±1% depending on the components in the air. In addition, the accuracy of the volume flow rate required for the blower 40 is ±5%. That is, the blower 40 can be controlled with sufficient accuracy.

The measurement accuracy required for the wind speed sensor 3, the temperature sensor 4, and the pressure sensor 5 and the arrangement positions thereof should be set such that the error of i calculated by Equation (1) is smaller than the error of the volume flow rate required for the blower 40. The types and the arrangement positions of the wind speed sensor 3, the temperature sensor 4, and the pressure sensor 5 can be selected within a range satisfying this condition. Therefore, the wind speed sensor 3, the temperature sensor 4, and the pressure sensor 5 may not necessarily be provided inside the first pipe 1 or the second pipe 2.

In step S13, an instruction to set the corrected rotational speed i obtained in step S11 as the rotational speed of the blower 40 is issued. In other words, the controller 20 corrects the flow rate of the gas flowing through the first pipe 1 and the second pipe 2.

In step S14, it is determined whether or not a command to end the operation is issued. When the end command is issued, the operation of the air volume adjusting device 60 ends. If no end command is issued, the process proceeds to step S15.

In step S15, it is determined whether or not a predetermined time has elapsed. When the predetermined time has elapsed, the process returns to step S10, and sensor values are acquired again. When the predetermined time has not elapsed, the process waits until the predetermined time elapses. The predetermined time is a cycle time of feedback control, and is appropriately set in a range of, for example, several seconds to several tens of minutes.

As described above, the waste powder collecting apparatus 100 of the present embodiment can achieve the following effects.

The waste powder collecting apparatus 100 includes the filter section 34, the flow straightener 10 that discharges the exhaust gas filtered by the filter section 34 from the exhaust port 10b, and the blower 40 as a blower section that sucks the exhaust gas. The flow straightener 10 includes the first pipe 1, the second pipe 2 disposed inside the first pipe 1, the wind speed sensor 3 as a wind speed detector disposed in the second pipe 2 to measure the mass flow rate of the gas flowing through the second pipe 2, and the temperature sensor 4 as a temperature detector disposed in the first pipe 1 to measure the temperature of the exhaust gas. The pressure sensor 5 as a pressure detector that measures the pressure of the outside air is provided outside the flow straightener 10. The waste powder collecting apparatus 100 corrects the rotational speed of the blower 40 on the basis of the detected values of the sensor group of the wind speed sensor 3, temperature sensor 4, and the pressure sensor 5.

Accordingly, the rotational speed of the blower 40 is corrected on the basis of the detected atmospheric pressure value, the detected temperature value, and the detected mass flow rate, thereby making it possible to control the air volume by the volume flow rate in consideration of the change in the air density. Therefore, the waste powder collecting apparatus 100 including the air volume adjusting device 60 controls the air volume by the volume flow rate, and thereby can control the rotational speed of the blower 40 so that the volume flow rate of the gas flowing into the filter section 34 is constant. This is different from a known apparatus which controls the air volume by the mass flow rate, so that the volume flow rate changes according to the change in air pressure or temperature. In addition, the temperature sensor 4 and the pressure sensor 5 can employ known small general-purpose sensors, and the wind speed sensor 3 can employ a small general-purpose sensor of a mass flow rate type.

Therefore, it is possible to provide the waste powder collecting apparatus 100 that can control the air volume by the volume flow rate with a simple configuration.

In addition, the temperature sensor 4 is a thermistor, the pressure sensor 5 is a piezoresistive pressure sensor, and the wind speed sensor 3 is a thermal flow sensor.

Accordingly, the temperature detector, the pressure detector, and the wind speed detector can be constituted of general-purpose small sensors, and the waste powder collecting apparatus 100 that controls the air volume by the volume flow rate can be provided simply and inexpensively.

In addition, the flow straightener 10 is not limited to a flow straightener having the double annular structure in which the second pipe 2 is concentrically disposed in the first pipe 1, and may be a pipe having a single structure. The shape of the cross section orthogonal to the flow is not limited to a circular shape, and may be another shape such as a quadrangular shape.

As can be seen from Equation (1), the controller 20 can also be interpreted as increasing the rotational speed of the blower 40 as the measured pressure increases, decreasing the rotational speed of the blower 40 as the measured temperature increases, and decreasing the rotational speed of the blower 40 as the measured mass flow rate increases.

### Second Embodiment

### Application to Sheet Manufacturing Apparatus

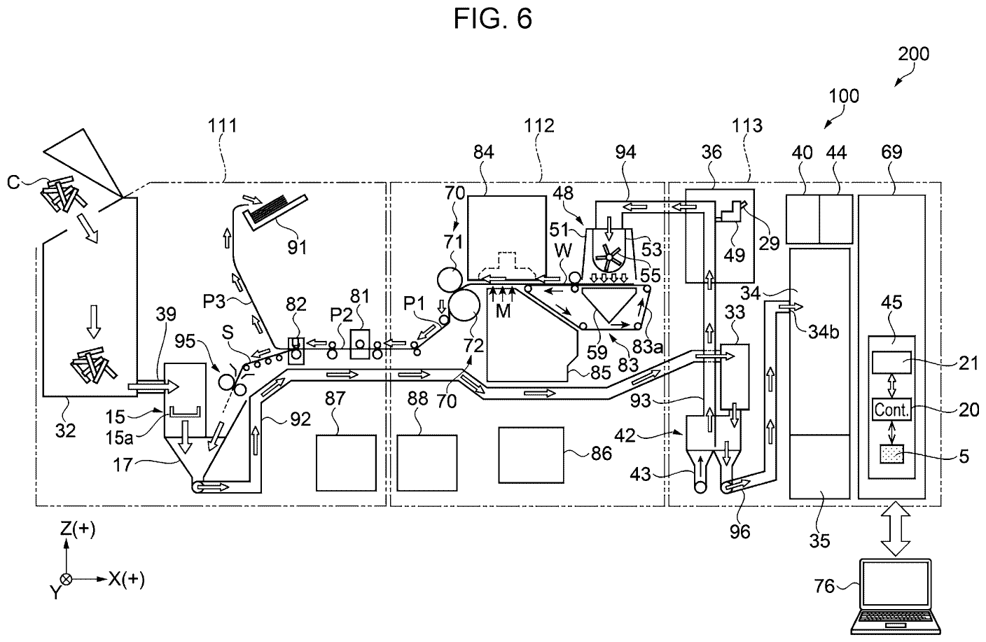

FIG. 6 is a schematic configuration diagram of a sheet manufacturing apparatus.

The above-described waste powder collecting apparatus 100 can be suitably applied to a sheet manufacturing apparatus 200.

The sheet manufacturing apparatus 200 manufactures sheets from pieces of paper such as waste paper through a dry process. Note that the manufacturing process performed by the sheet manufacturing apparatus 200 is not limited to the dry process, and may be a wet process. In the present embodiment, the dry process refers to a process that is not performed in a liquid but in the air such as the atmosphere.

As illustrated in FIG. 6, the sheet manufacturing apparatus 200 includes a first unit group 111, a second unit group 112, and a third unit group 113. The first unit group 111, the second unit group 112, and the third unit group 113 are supported by a frame (not illustrated).

In FIG. 6, the directions in which a paper piece C, a sheet P3, a slit piece S, an unnecessary scrap, and the like move are indicated by white arrows. In the sheet manufacturing apparatus 200, the side to which the paper piece C, a web W, the sheet P3, and the like are transported may also be referred to as the downstream side, and the opposite side in the transport direction may also be referred to as the upstream side. In the following description, a set of paper pieces C is also simply referred to as a paper piece C.

The sheet manufacturing apparatus 200 manufactures the sheet P3 from the paper piece C. In the sheet manufacturing apparatus 200, the first unit group 111, the second unit group 112, and the third unit group 113 are arranged in this order from the minus side to the plus side of the X direction. The above-described waste powder collecting apparatus 100 is housed in the third unit group 113.

The paper piece C is stored in a storing section 32 of the first unit group 111, and is supplied from the storing section 32 to a merging section 17 through a discharge section 39 and then transported to the third unit group 113 through a pipe 92. Then, the paper piece C is subjected to defibrating and the like in the third unit group 113 to be fibers and then to be a mixture containing a binder. The mixture is transported to the second unit group 112 through a pipe 94. The mixture is formed into the web W in the second unit group 112, and then formed into a sheet P1 having a strip shape. The sheet P1 having a strip shape is cut into sheets P3 in the first unit group 111.

The first unit group 111 includes the storing section 32, a measurement section 15, the merging section 17, and the pipe 92. In the first unit group 111, these components are arranged in this order from the upstream side toward the downstream side. In addition, the first unit group 111 includes a first cutter 81, a second cutter 82, a tray 91, and a shredding section 95. Each of the first cutter 81 and the second cutter 82 cuts the sheet P1 having a strip shape into the sheets P3 having a predetermined shape. Furthermore, the first unit group 111 includes a water supplier 87. The water supplier 87 may be a water storage tank. The water supplier 87 supplies water for humidification to a first humidifier 85 and a second humidifier 86, which will be described later, through a water supply pipe (not illustrated).

The storing section 32 stores the paper piece C, which is a raw material of the sheet P3, and supplies the paper piece C toward the downstream side through the discharge section 39. The paper piece C contains fibers such as cellulose, and is, for example, shredded waste paper. The inside of the storing section 32 is supplied with humidified air by the second humidifier 86 included in the second unit group 112.

The paper piece C is temporarily stored in the storing section 32 and then transported to the measurement section 15 via the discharge section 39. The sheet manufacturing apparatus 200 may include a shredder that shreds the paper piece C and the like on the upstream side of the storing section 32.

The measurement section 15 includes a sensor 15a and a supply mechanism (not illustrated). The sensor 15a measures the mass of the paper piece C. The supply mechanism supplies the paper piece C weighed by the sensor 15a to the merging section 17 on the downstream side. That is, the measurement section 15 weighs the paper piece C by the sensor 15a for each predetermined mass, and supplies the paper piece C to the merging section 17 on the downstream side by the supply mechanism.

The sensor 15a can employ either a digital or analog weighing mechanism. More specifically, the sensor 15a may be a physical sensor, such as a load cell, a spring balance, a balance scale, or the like. In the present embodiment, the sensor 15a is a load cell. The predetermined mass of the paper piece C weighed by the sensor 15a is, for example, about several grams to several tens of grams.

The weighing and supplying processes of the paper piece C by the measurement section 15 are batch processing. That is, the paper piece C is intermittently supplied from the measurement section 15 to the merging section 17. The measurement section 15 may include a plurality of combinations of sensor 15a and supply mechanism, and may operate the plurality of sensors 15a at different timings, thereby improving the efficiency of the weighing and supplying processes. The sheet manufacturing apparatus 200 may include two sensors 15a and supply mechanisms attached to the respective sensors 15a. Accordingly, the paper piece C is transported alternately from the two pairs of sensor 15a and supply mechanism to the merging section 17.

In the merging section 17, shredded pieces of a slit piece S supplied from the shredding section 95 are added to and mixed with the paper piece C supplied from the measurement section 15. Details of the slit piece S and the shredding section 95 will be described later. The paper piece C mixed with the shredded pieces flows from the merging section 17 into the pipe 92.

The pipe 92 transports the paper piece C from the first unit group 111 to the third unit group 113 via the second unit group 112, using a suction airflow generated by a defibrator 33 on the downstream side.

The third unit group 113 includes the defibrator 33, which is a dry type defibrator, a separator 42, a pipe 93, a mixer 36, and the pipe 94. Furthermore, the third unit group 113 includes a pipe 96 branching from the separator 42, and the waste powder collecting apparatus 100 and a power supply section 69 to which the pipe 96 is connected.

The paper piece C transported through the pipe 92 flows into the defibrator 33. The defibrator 33 defibrates the paper piece C supplied from the measurement section 15 into fibers through the dry process. The defibrator 33 can employ a known defibrating mechanism.

The defibrator 33 may have a configuration, for example, described below. The defibrator 33 includes a stator and a rotor. The stator has a substantially cylindrical inner surface. The rotor is installed inside the stator and rotates along the inner surface of the stator. The small piece of the paper piece C is interposed between the inner surface of the stator and the rotor, and is defibrated by a shearing force generated therebetween. As a result, entangled fibers contained in the paper piece C are disentangled. The paper piece C is made into fibers and then transported to the separator 42.

The separator 42 sorts the defibrated fibers. The separator 42 removes ingredients contained in the fibers which are unnecessary for the manufacture of the sheet P3. More specifically, the separator 42 sorts relatively long fibers and relatively short fibers. The relatively short fibers may cause a decrease in the strength of the sheet P3, and thus are sorted by the separator 42. In addition, the separator 42 also removes colorants, additives, and the like contained in the paper piece C. The separator 42 can employ a known technique such as a disk mesh technique. The inside of the separator 42 is supplied with humidified air by the second humidifier 86 of the second unit group 112.

The sorted raw material fibers are transported to the mixer 36 through the pipe 93 by an airflow generated by a blower (not illustrated) disposed at the tip of an airflow pipe 43.

Then, the gas containing waste powder passes through the pipe 96 and flows into the filter section 34 from the intake ports 34b of the waste powder collecting apparatus 100. When the gas flows into the filter section 34, the waste powder is removed from the gas by the filters 13 and the resultant gas is then discharged from the exhaust port 10b of the flow straightener 10, as described with reference to FIG. 2. The waste powder is collected inside the waste powder box 35. As described above, the waste powder collecting apparatus 100 is a bag filter, and includes the blower 40 that generates an exhaust airflow and a compressor 44 that generates compressed air for cleaning the filters.

The mixer 36 mixes a powder additive, such as a binder, with the fibers in the air to form the mixture. The mixer 36 includes a powder supply mechanism 49. The powder supply mechanism 49 includes a built-in hopper. The powder supply mechanism 49 is equipped with a powder supply container 29. Although not illustrated, the mixer 36 includes a flow path through which the fibers are to be transported, a valve, and a fan, in addition to the powder supply mechanism 49.

The hopper sends out powder of the binder supplied from the powder supply container 29 into the flow path. The sheet manufacturing apparatus 200 may use starch as the binder for the fibers. The valve (not illustrated) adjusts the flow rate, that is, the mass of the binder supplied from the hopper into the flow path. As a result, the mixing ratio between the fibers and the binder is adjusted. Note that the mixer 36 may include similar structures that supply a colorant, an additive, or the like, in addition to the powder supply container 29 and the powder supply mechanism 49 that supply the binder. The fan of the mixer 36 mixes the binder and the like in the air to form the mixture while transporting the fibers downstream by a generated airflow. The mixture flows from the mixer 36 into the pipe 94.

The power supply section 69 includes a power supply device (not illustrated) that supplies power to the control substrate 45 and the sheet manufacturing apparatus 200. The power supply section 69 distributes externally supplied power to individual components of the sheet manufacturing apparatus 200.

On the control substrate 45, the controller 20, the storage unit 21, and the pressure sensor 5, described above, are mounted, so as to be able to measure the atmospheric pressure in the environment in which the waste powder collecting apparatus 100 is installed. In a preferred example, the controller 20 and the storage unit 21 also have a function of integrally controlling the entire sheet manufacturing apparatus 200.

The control substrate 45 may be connected to a computer 76. The computer 76 is, for example, a notebook computer, and stores a control program for the entire sheet manufacturing apparatus 200 including the waste powder collecting apparatus 100.

The second unit group 112 accumulates and compresses the mixture containing the fibers to form the sheet P1 having a strip shape, which is a recycled paper sheet. The second unit group 112 includes an accumulator 48, a first transport section 83, a second transport section 84, the first humidifier 85, the second humidifier 86, a drainer 88, and a forming section 70.

In the second unit group 112, the accumulator 48, the first transport section 83, the second transport section 84, the first humidifier 85, and the forming section 70 are arranged in this order from the upstream side to the downstream side. The second humidifier 86 is disposed below the first humidifier 85.

The accumulator 48 accumulates the mixture containing the sorted fibers in the air to generate the web W. The accumulator 48 includes a drum member 53, a blade member 55 disposed inside the drum member 53, a housing 51 that accommodates the drum member 53, and an aspirator 59. The mixture is fed into the drum member 53 through the pipe 94.

The first transport section 83 is disposed below the accumulator 48. The first transport section 83 includes a mesh belt 83a and five tension rollers (not illustrated) between which the mesh belt 83a is stretched. The aspirator 59 is disposed opposite the drum member 53 with the mesh belt 83a therebetween in the direction along the Z-axis.

The blade member 55 is located inside the drum member 53 and is rotationally driven by a motor (not illustrated). The drum member 53 is a semicylindrical sieve. The drum member 53 has a mesh having the function of a sieve on a side surface facing downward. The drum member 53 allows particles of fibers, mixtures, and the like that are smaller than the size of the mesh openings of the sieve to pass therethrough from the inside to the outside.

The mixture is discharged to the outside of the drum member 53 while being stirred by the blade member 55 rotating in the drum member 53. The inside of the drum member 53 is supplied with humidified air by the second humidifier 86.

The aspirator 59 is disposed below the drum member 53. The aspirator 59 sucks the air inside the housing 51 via a plurality of holes formed in the mesh belt 83a. The plurality of holes of the mesh belt 83a allow air to pass therethrough, but do not allow the fibers, the binder, and the like contained in the mixture to pass therethrough easily. Accordingly, the mixture discharged to the outside of the drum member 53 is suctioned downward together with the air. The aspirator 59 is a known suction device such as a blower.

The mixture is dispersed in the air inside the housing 51 and is accumulated on the upper surface of the mesh belt 83a by gravity and the suction force applied by the aspirator 59, thereby forming the web W.

The mesh belt 83a is an endless belt and is stretched between the five tension rollers. The mesh belt 83a is rotated counterclockwise in FIG. 6 by the rotation of the tension rollers. As a result, the mixture is continuously accumulated on the mesh belt 83a to form the web W. The web W contains a relatively large amount of air and is soft and swollen. The first transport section 83 transports the formed web W downstream by the rotation of the mesh belt 83a.

The second transport section 84 transports the web W on the downstream side of the first transport section 83, instead of the first transport section 83. The second transport section 84 separates the web W from the upper surface of the mesh belt 83a and then transports the web W to the forming section 70. The second transport section 84 is disposed above the transport path of the web W and slightly upstream of the initial point from which the mesh belt 83a returns. The plus side of the X direction of the second transport section 84 overlaps the minus side of the X direction of the mesh belt 83a in the vertical direction. The second transport section 84 includes a transport belt, a plurality of rollers, and a suction mechanism, which are not illustrated. The transport belt is provided with a plurality of holes that allow air to pass therethrough. The transport belt is stretched by the plurality of rollers and is moved by the rotation of the rollers.

The second transport section 84 causes the upper surface of the web W to be sucked to the lower surface of the transport belt by negative pressure generated by the suction mechanism. When the transport belt moves in this state, the web W is sucked to the transport belt and transported to the downstream side.

The first humidifier 85 humidifies the web W containing the fibers accumulated by the accumulator 48 of the second unit group 112. More specifically, the first humidifier 85 is, for example, a mist humidifier, and supplies mist M from below to the web W transported by the second transport section 84, thereby humidifying the web W. The first humidifier 85 is disposed below the second transport section 84 and faces the web W transported by the second transport section 84 in the direction along the Z-axis. The first humidifier 85 can employ a known humidifying device, for example, an ultrasonic humidifying device.

Humidifying the web W with the mist M improves the function of the starch as the binder, and increases the strength of the sheet P3. In addition, since the web W is humidified from below, droplets derived from the mist do not fall onto the web W. Furthermore, since the web W is humidified from the side opposite to the contact surface between the transport belt and the web W, sticking of the web W to the transport belt is reduced. The second transport section 84 transports the web W to the forming section 70.

The forming section 70 includes processing rollers 71 and 72. The processing rollers 71 and 72 press the web W containing the fibers to form the sheet P1 having a strip shape. The processing rollers 71 and 72 forms a pair, and each includes a built-in electric heater that has the function of raising the temperature of the corresponding roller surface.

The processing rollers 71 and 72 are members each having a substantially cylindrical shape. The rotation axes of the processing rollers 71 and 72 extend along the Y-axis. The processing roller 71 is disposed substantially above the transport path of the web W, whereas the processing roller 72 is disposed substantially below the transport path. The processing rollers 71 and 72 are disposed with a gap between the side surfaces thereof. The size of the gap corresponds to the thickness of the sheet P3 to be manufactured.

The processing rollers 71 and 72 are rotationally driven by a stepping motor (not illustrated). The web W is fed downstream, while being pinched between the processing roller 71 and the processing roller 72 to be heated and pressurized. That is, the web W continuously passes through the forming section 70 and is press-formed while being heated. By using the processing rollers 71 and 72 as a pair of forming members, the web W can be efficiently heated and pressed.

When the web W, which is soft and contains a large amount of air, passes through the forming section 70, the amount of air in the web W decreases and the fibers therein are bound together by the binder. In this way, the web W is formed into the sheet P1 having a strip shape. The sheet P1 having a strip shape is transported to the first unit group 111 by transport rollers (not illustrated).

The second humidifier 86 is disposed below the first humidifier 85. The second humidifier 86 can employ a known evaporative type humidifying device. The evaporative type humidifying device is, for example, a humidifying device that generates humidified air by blowing air onto a wet non-woven fabric to vaporize the moisture.

The second humidifier 86 humidifies a predetermined region of the sheet manufacturing apparatus 200. The predetermined region is one or more of the storing section 32, the separator 42, and the inside of the drum member 53 of the accumulator 48. More specifically, the second humidifier 86 supplies humidified air to the above region through a plurality of pipes (not illustrated). In each of the above-described components, the humidified air decreases the electrostatic charge of the paper piece C, the fibers, and the like, thereby suppressing adhesion of the paper piece C, the fibers, and the like to the members due to static electricity.

The drainer 88 is a drainage tank. The drainer 88 collects and stores waste moisture that has been used by the first humidifier 85, the second humidifier 86, and the like. The drainer 88 is detachable from the sheet manufacturing apparatus 200 as necessary to dump the stored water therefrom.

The sheet P1 having a strip shape transported to the first unit group 111 reaches the first cutter 81. The first cutter 81 cuts the sheet P1 having a strip shape in a direction intersecting the transport direction, for example, the direction along the Y-axis. The sheet P1 having a strip shape is cut into a single-cut sheet P2 by the first cutter 81. The single-cut sheet P2 is transported from the first cutter 81 to the second cutter 82.

The second cutter 82 cuts the single-cut sheet P2 in a direction parallel to the transport direction. More specifically, the second cutter 82 cuts both side portions, in the direction along the X-axis, of the single-cut sheet P2. As a result, the single-cut sheet P2 is formed into the sheet P3 having a predetermined shape, for example, an A4 size or an A3 size.

When the second cutter 82 cuts the single-cut sheet P2 into the sheet P3, the slit pieces S, which are scraps, are produced. The slit pieces S are transported downward to the shredding section 95, which is a shredder. The shredding section 95 shreds the slit pieces S into shredded pieces, and supplies them to the merging section 17. A mechanism for weighing the shredded pieces of the slit pieces S and supplying them to the merging section 17 may be disposed between the shredding section 95 and the merging section 17.

The sheets P3 are transported substantially upward and are stacked on the tray 91. In this way, the sheets P3 are manufactured by the sheet manufacturing apparatus 200. The sheets P3 are usable as, for example, a replacement for copy paper.

In other words, the sheet manufacturing apparatus 200 includes the waste powder collecting apparatus 100, the defibrator 33 that defibrates a raw material, the accumulator 48 that accumulates a material and forms the web W, and the forming section 70 that compresses the web W and forms a sheet, and the waste powder collecting apparatus 100 collects waste powder from the raw material defibrated by the defibrator 33.

As described above, the sheet manufacturing apparatus 200 of the present embodiment can achieve the following effects.

The sheet manufacturing apparatus 200 includes the waste powder collecting apparatus 100, the defibrator 33 that defibrates a raw material, the accumulator 48 that accumulates a material and forms the web W, and the forming section 70 that compresses the web W and forms a sheet, and the waste powder collecting apparatus 100 collects waste powder from the raw material defibrated by the defibrator 33.

Accordingly, the sheet manufacturing apparatus 200 includes the waste powder collecting apparatus 100 that controls the air volume by the volume flow rate with a simple configuration. Therefore, even when the temperature or the air pressure in the operating environment changes, it is possible to control the air volume by the volume flow rate, thereby controlling the rotational speed of the blower 40 so that the volume flow rate of the gas flowing into the filter section 34 is constant.

It is therefore possible to provide the sheet manufacturing apparatus 200 that can control the air volume by the volume flow rate with a simple configuration.

The sheet manufacturing apparatus 200 can also be regarded as a filter apparatus. Furthermore, an apparatus used for a purpose other than sheet manufacturing can also be regarded as a filter apparatus.

What is claimed is:

1. A filter apparatus comprising:
a filter;
a pipe;
a blower that sucks, through the pipe, air filtered by the filter;
a wind speed sensor that measures a mass flow rate of gas flowing through the pipe;
a temperature sensor that measures a temperature;
a pressure sensor that measures an air pressure; and
a processor that controls suction of the blower, based on the air pressure measured by the pressure sensor, the temperature measured by the temperature sensor, and the mass flow rate measured by the wind speed sensor.

2. The filter apparatus according to claim 1, wherein
the processor causes the blower to perform the suction more strongly as the air pressure measured by the pressure sensor increases.

3. The filter apparatus according to claim 1, wherein
the processor causes the blower to perform the suction more weakly as the temperature measured by the temperature sensor increases.

4. The filter apparatus according to claim 1, wherein
the temperature sensor is a thermistor,
the pressure sensor is a piezoresistive pressure sensor, and
the wind speed sensor is a thermal flow sensor.

5. The filter apparatus according to claim 1, further comprising:
a defibrator that defibrates a raw material;
an accumulator that accumulates a material to form a web;
a forming section that compresses the web to form a sheet; and
a waste powder pipe that sends waste powder to the filter, the waste powder being generated from the raw material defibrated by the defibrator.
